(19) United States
(12) Patent Application Publication
(10) Pub. No.: US 2024/0428703 A1
(43) Pub. Date: Dec. 26, 2024

(54) System for Training and Coordinating Athletes

(71) Applicant: Coachwhisperer GmbH, Jena (DE)

(72) Inventors: Alexandra WOCZINSKI, Köln (DE); Julien Pascal THEN, Jena (DE); Philipp ZACHER, Jena (DE)

(73) Assignee: Coachwhisperer GmbH, Jena (DE)

(21) Appl. No.: 18/687,682

(22) PCT Filed: Aug. 19, 2022
(86) PCT No.: PCT/EP2022/073217

§ 371 Date: Feb. 28, 2024

(30) Foreign Application Priority Data
Aug. 31, 2021 (DE) 10 2021 122 521.3

(51) Int. Cl. G09B 19/00; A63B 24/00

(52) U.S. Cl. CPC G09B 19/0038; A63B 24/0021; A63B 2225/50; A63B 2230/04

(57) ABSTRACT

A system for training and coordinating athletes comprises a transponder device, a headphone device, and a base station. The transponder device is adapted to be worn on the body by an athlete. The headphone device is adapted to be reversibly inserted into an outer auditory canal of an ear of the athlete and to be coupled to the transponder device via a first wireless communication link. The headphone device comprises a loudspeaker unit for outputting an acoustic signal and is adapted to receive an audio signal from the transponder device via the first wireless communication link and to output an acoustic signal corresponding to the audio signal into the outer auditory canal of the athlete by means of the loudspeaker unit. The headphone device further comprises a sensor unit for detecting a signal pertaining to a blood circulation of the athlete and is adapted to transmit the detected signal pertaining to the blood circulation of the athlete to the transponder device via the first wireless communication link. The base station is adapted to be coupled to the transponder device via a second wireless communication link and to receive from the transponder device the signal pertaining to the blood circulation of the athlete via the second wireless communication link.

### TECHNICAL FIELD

The disclosure relates to a system for training and coordinating athletes by means of wireless communication systems, in particular by the trainer of a team sport such as football.

### BACKGROUND

Technical assistance systems for supporting a training program of an athlete are now widespread. For example, the US application US 2017/0333754 A1 discloses a training system in which personalised training instructions can be wirelessly transmitted to the athlete via headphones which he wears over one or both ears. The headphone unit can also comprise additional sensors for capturing vital data of the athlete.

A problem of this previously known system is that the headphone unit becomes relatively large and bulky due to the plurality of contained sensors so that the wearing comfort of the athlete is limited. In addition, such a headphone unit can contribute to an increased risk of injury of the athlete, in particular in team sports with body contact such as football, handball or basketball.

### SUMMARY OF THE DISCLOSURE

Against the background of the aforementioned problems, the object of the present disclosure is to provide an improved system for training and coordinating athletes which has a high wearing comfort and at the same time low risk of injury and is in particular suitable for team sports.

This object is achieved by a system for training and coordinating athletes according to the independent claims 1 and 15. The dependent claims relate to advantageous further developments.

The disclosure relates in a first aspect to a system for training and coordinating athletes. The system comprises a transponder device, a headphone device and a base station. The transponder device is adapted to be worn on the body by an athlete. The headphone device is adapted to be reversibly inserted into an outer auditory canal of an ear of the athlete and to be coupled to the transponder device via a first wireless communication link. The headphone device comprises a loudspeaker unit for outputting an acoustic signal and is adapted to receive an audio signal from the transponder device via the first wireless communication link and to output an acoustic signal corresponding to the audio signal into the outer auditory canal of the athlete by means of the loudspeaker unit. The headphone device further comprises a sensor unit for detecting a signal pertaining to a blood circulation of the athlete and is adapted to transmit the detected signal pertaining to the blood circulation of the athlete to the transponder device via the first wireless communication link. The base station is adapted to be coupled to the transponder device via a second wireless communication link and to receive from the transponder device the signal pertaining to the blood circulation of the athlete via the second wireless communication link.

The three-component construction of the system according to the disclosure with transponder device, headphone device and base station is associated with numerous advantages. The transponder device and the headphone device can both be worn on the body of the athlete, wherein the headphone device is coupled to the transponder device via the first wireless communication link and the transponder device is coupled to the base station via the second wireless communication link. The base station can be used by the trainer, for example, to retrieve the signals pertaining to the blood circulation of the athlete, which are recorded via the respective headphone device, from the transponder device and to deduce therefrom the physical performance state of the corresponding athlete. In addition, in embodiments of the disclosure, the trainer can transmit audio signals, for example training commands, to individual or all athletes in a targeted manner by means of the base station and via the transponder device, wherein the corresponding acoustic signals are then played into the respective athlete via the loudspeaker unit of the headphone device.

In embodiments of the disclosure, the headphone device according to the disclosure can be restricted to the functionalities of a loudspeaker for transmitting acoustic signals to the athlete, for example instructions of its trainer, and of a sensor for capturing the signals pertaining to the blood circulation of the athlete and can therefore be designed in a particularly small size. In embodiments, all other functionalities, in particular the communication with the base station, can be outsourced into the spatially separate transponder device. Since the headphone device according to the disclosure can be inserted into the outer auditory canal of the athlete, it does not represent a significant additional risk of injury for the athlete. The wearing of the headphone device according to the disclosure is therefore generally not associated with significant restrictions of its mobility or performance for the athlete and the wearing comfort is correspondingly high. In addition, additional belts or pulse bands for capturing the blood circulation of the athlete, which could restrict the freedom of movement of the athlete, can be dispensed with.

In embodiments of the disclosure, the communication of the headphone device with the base station or the trainer can take place completely via the transponder device which is spatially separate from the headphone device and which can optionally also receive additional movement data of the athlete. For the connection between the headphone device and the transponder device, which are both worn on the body of the athlete, a low-range and low-energy data connection is generally sufficient due to the small spatial distance so that the technical requirements on the data processing and energy storage units of the headphone device are correspondingly low and the structural size thereof can be further reduced.

Overall, the modular three-component construction and the division of the functionalities between the transponder device and the headphone device result in a system for training and coordinating athletes which combines a high wearing comfort with a low risk of injury and is in particular also outstandingly suitable for team sports such as football, handball or basketball.

In the context of the present disclosure, a transponder device can denote any device which is configured to exchange communication signals with the headphone device and the base station. In particular, the transponder device can be adapted to receive a signal from the headphone device and to transmit a possibly modified signal to the base station. Further, the transponder device can be adapted to receive a signal from the base station and to transmit a possibly modified signal to the headphone device.

The transponder device and/or the headphone device and/or the base station of the system can in particular each be different from one another and/or spatially separate.

In some embodiments, the communication between the base station and the transponder device can take place exclusively via the second wireless communication link. In other embodiments, the communication between the base station and the transponder device can additionally also comprise other wireless or wired components.

According to one embodiment, the signal pertaining to the blood circulation of the athlete comprises a heart rate or pulse rate and/or a blood pressure.

Both the heart rate (also referred to as heart frequency) and the blood pressure can be determined, in particular optically determined, reliably and invisibly for the athlete by means of signals recorded within the external auditory canal.

According to one embodiment, the sensor unit comprises an optoelectronic sensor.

The optoelectronic sensor can be adapted to detect a heart rate and/or a blood pressure of the athlete by means of a reflected optical signal emitted and detected within the external auditory canal.

According to one embodiment, the sensor unit can be adapted to be received within the external auditory canal, in particular to be completely received within the external auditory canal.

Within the meaning of this disclosure, the external auditory canal can be understood to mean the region of the ear which lies spatially between the auricle and the eardrum.

According to one embodiment, the headphone device can be an in-the-ear headphone device, in particular an in-the-canal headphone device.

In particular, the entire headphone device can be adapted to be completely received within the external auditory canal.

In this way, the risk of injury to the athlete by way of the headphone device is largely reduced, while at the same time the wearing comfort for the athlete is particularly high.

According to one embodiment, in particular a shape of the headphone device can be adapted to the external auditory canal of the athlete.

For example, the headphone device can be an otoplastic molded individually for the corresponding athlete, which ensures an optimal fit in the ear of the athlete. As a result, both an ideal sealing of the auditory canal from an acoustic point of view can be realized and a good mechanical coupling can be ensured, in order to prevent a possible slipping/falling out of the headphone device.

In some embodiments, an antenna-like plastic rod or silicone rod can be attached to the outwardly directed side of the headphone device, by means of which the headphone device can be removed from the ear of the athlete.

According to one embodiment, the transponder device can additionally comprise a motion data sensor unit for capturing motion data of the athlete.

In particular, the transponder device can be adapted to transmit the detected motion data to the base station via the second wireless communication link.

The motion data can comprise any data pertaining to the physical motion of the athlete.

For example, the motion data sensor unit can comprise a gyro sensor for capturing rotational movements of the athlete and/or an acceleration sensor for capturing movement accelerations of the athlete and/or a magnetic field sensor for capturing an orientation of the athlete in space.

The captured motion data can be stored in the transponder device for later processing and/or can be transmitted to the base station via the second wireless communication link.

In this way, the trainer can additionally include the detected motion data of the athlete in addition to the signals pertaining to the blood circulation of the athlete for estimating the physical performance state of the athlete. In addition, the motion data can simplify a later analysis of the training.

The capture of the additional motion data by means of the transponder device which is functionally and spatially separate from the headphone device makes it possible to functionally relieve the headphone device so that it can be formed with a particularly small structural size, as a result of which the wearing comfort of the headphone device is additionally increased and the risk of injury to the athlete emanating from the headphone device is at the same time minimized.

According to one embodiment, the base station can be adapted to determine a spatial position of the transponder device.

In this way, for example, the spatial position of the corresponding athlete can be determined and tracked in a temporally resolved manner, for example for a later analysis of the training.

For this purpose, the transponder device can comprise, for example, a position determination unit, in particular a position determination unit based on satellite navigation.

Further, in one further development, the transponder device can be adapted to transmit its spatial position detected by means of the position determination unit to the base station via the second wireless communication link.

Alternatively or additionally, the system can be adapted to determine the spatial position of the transponder device by means of triangulation and/or lateration, in particular using the second wireless communication link.

According to the disclosure, the triangulation can comprise any techniques for determining the position of the transponder device by means of angle measurement.

According to the disclosure, the lateration can comprise any techniques for determining the position of the transponder device by means of distance measurement and/or signal propagation time measurement. The lateration can comprise, for example, a trilateration or a multilateration.

The determination of the spatial position of the transponder device by means of triangulation and/or lateration can take place, for example, by the base station or by network units connected to the base station.

The network units can be coupled to the base station via a wired communication link and to the transponder device via the second wireless communication link. In other embodiments, the network units can be coupled both to the base station and to the transponder device via the second wireless communication link.

According to one embodiment, the network units comprise Wi-Fi routers or are Wi-Fi routers.

In particular, the network units, in particular the Wi-Fi routers, can be ultra-wideband-capable.

In some embodiments, the determination of the spatial position of the transponder device by means of triangulation and/or lateration can also take place by further transponder devices which have the same function as the transponder device and are adapted to be worn on the body by further athletes.

According to one embodiment, the base station comprises a graphical display unit and is adapted to display the determined spatial position of the transponder device on the graphical display unit.

This embodiment can, for example, allow the trainer to graphically track or record the spatial position of one or more athletes during a training or competition.

The audio signal according to the disclosure can be any signal which is suitable for being transmitted to the athlete during a training or competition.

In particular, the audio signal or the acoustic signal corresponding to the audio signal can comprise a warning sound and/or a predefined sound and/or a predefined sound and/or a voice message.

The audio signal can comprise, for example, a training instruction which a trainer transmits to one or more athletes by means of the base station. In other examples, the audio signal can comprise chimes or tones or sounds which are automatically played into the corresponding athlete, for example depending on specific game situations, motion data or the signals pertaining to the blood circulation of the athlete. In this case, for example, techniques of neurolinguistic programming can also be used.

The audio signal can be generated by the transponder device or can be generated by the base station and transmitted to the headphone device by means of the transponder device.

According to one embodiment, the transponder device is adapted to provide the audio signal to the headphone device via the first wireless communication link.

In one embodiment, the base station can be adapted to cause the transponder device, by using the second wireless communication link, to provide the audio signal to the headphone device.

The base station can also be adapted to transmit the audio signal to the transponder device by using the second wireless communication link.

According to one embodiment, the base station further comprises a microphone unit and is adapted to record a sound, in particular a voice message of a user, for example a trainer of the athlete, by means of the microphone unit and to transmit the audio signal, which pertains to the sound, to the transponder device by using the second wireless communication link.

In one embodiment, the transponder device and/or the base station is adapted to analyze the signal pertaining to the blood circulation of the athlete detected by the headphone device.

In one further development, the transponder device and/or the base station is adapted to provide the audio signal to the headphone device, in particular to provide it in an automated manner, depending on the analyzed signal pertaining to the blood circulation of the athlete.

In this way, the system according to the disclosure can react automatically to the performance state of the athlete and can play in chimes, for example in the event of an imminent physical overload of the athlete, which chimes can have a calming or heart rate-lowering effect.

According to one embodiment, the transponder device and/or the base station can further comprise a memory unit for storing the detected signal pertaining to the blood circulation of the athlete and/or the motion data and/or the spatial position and/or the audio signal and/or the acoustic signal.

In this way, the athlete or his trainer is made easier to prepare or analyze the course of the training.

In one embodiment, the transponder device and/or the base station can further comprise an analysis unit for analyzing the detected signal pertaining to the blood circulation of the athlete and/or the motion data and/or the spatial position and/or the audio signal and/or the acoustic signal.

According to one embodiment, the system additionally comprises a receiving station which is adapted to receive and/or hold the transponder device.

The receiving station can in particular be adapted to electrically charge the transponder device.

In one further development, the receiving station is communicatively coupled to the base station and is adapted to read out the detected signal pertaining to the blood circulation of the athlete and/or the motion data and/or the spatial position and/or the audio signal and/or the acoustic signal from the transponder device and to transmit them to the base station.

In principle, all suitable wireless communication links can be used as the first wireless communication link and as the second wireless communication link within the scope of the present disclosure.

The first wireless communication link and/or the second wireless communication link can comprise a bidirectional connection.

According to one embodiment, the second wireless communication link differs from the first wireless communication link. In other embodiments, the second wireless communication link can also coincide with the first wireless communication link.

According to one embodiment, the first wireless communication link comprises a Bluetooth connection.

In one embodiment, the second wireless communication link comprises a WiFi connection.

The second wireless communication link can use, for example, a User Datagram Protocol (UDP).

According to one embodiment, the system comprises at least one network unit which is connected between the base station and the transponder device, wherein the base station is adapted to couple to the at least one network unit, for example by using a wired communication link and/or a wireless communication link, in particular the second wireless communication link, and to communicate with the transponder device via the at least one network unit by using the second wireless communication link.

In the context of the present disclosure, a network unit can denote any device which is communicatively connected between the base station and the transponder device and is configured to exchange signals with both the base station and the transponder device.

Within the scope of the disclosure, any number of network units can be used.

A use of a plurality of network units allows a complete network coverage even of larger playing fields. In addition, using a plurality of network units, a spatial position of the transponder device or of the associated athlete can be determined by triangulation and/or lateration.

According to one embodiment, the network unit can be ultra-wideband-capable.

The network unit can be a Wi-Fi router or comprise a Wi-Fi router.

According to one embodiment, the transponder device can be adapted to be worn on the body by the athlete in a vest or in his sports clothing.

In this way, the transponder device can be worn on the body without significant restrictions of the freedom of movement of the athlete.

The transponder device and/or the headphone device and/or the base station and/or the loudspeaker unit and/or the sensor unit and/or the motion data sensor unit and/or the position determination unit and/or the microphone unit and/or the memory unit and/or the analysis unit and/or the receiving station and/or the graphical display unit can be configured within the scope of the teaching according to the disclosure both in hardware and in software or firmware or partly in hardware and partly in software/firmware.

Features of the disclosure have been described above with reference to an individual transponder device and to an individual headphone device. However, particular advantages also result in systems which are tailored to a plurality of athletes with which a transponder device and a headphone device are associated, for example for use in team sports such as football, handball or basketball.

The disclosure therefore also relates in a second aspect to a system for training and coordinating athletes, comprising a first plurality of transponder devices, a second plurality of headphone devices and a base station.

The first plurality of transponder devices is adapted to be worn on the body by an athlete.

The second plurality of headphone devices is adapted to be reversibly inserted into an outer auditory canal of an ear of the respective athlete and to be coupled to an associated transponder device of the first plurality of transponder devices via a first wireless communication link.

Here, each of the second plurality of headphone devices can comprise a loudspeaker unit for outputting a respective acoustic signal and can be adapted to receive a respective audio signal from the associated transponder device via the first wireless communication link and to output an acoustic signal corresponding to the respective audio signal into the outer auditory canal of the respective athlete by means of the loudspeaker unit.

Further, each of the second plurality of headphone devices can comprise a sensor unit for detecting a respective signal pertaining to a blood circulation of the respective athlete and can be adapted to transmit the respective detected signal pertaining to the blood circulation of the respective athlete to the associated transponder device via the first wireless communication link.

The base station is adapted to be coupled to each of the first plurality of transponder devices via a second wireless communication link and to receive from the respective transponder devices the signal pertaining to the blood circulation of the respective athlete via the second wireless communication link.

The second plurality can coincide with the first plurality.

The transponder devices and/or the headphone devices and/or the base station and/or the first wireless communication link and/or the second wireless communication link and/or the loudspeaker unit and/or the sensor unit according to the second aspect can have in embodiments of the disclosure all or some of those features which have been explained above with reference to the first aspect.

The system according to the disclosure allows the user to combine a plurality of athletes into groups and to address these groups in each case with specific audio signals.

According to one embodiment, the first plurality of transponder devices are adapted to set up, in particular to set up automatically, the second wireless communication link among themselves and possibly in cooperation with the base station.

For example, the first plurality of transponder devices can set up a Wi-Fi network, for example a mesh network, among themselves and with the base station. By means of this network, signals can be conducted efficiently and intelligently over the shortest path from the transmitter to the receiver.

According to one embodiment, the base station can be adapted to select a subset of the first plurality of transponder devices, in particular to select in response to a user input.

In one further development, the base station can further be adapted to cause the selected transponder device or the selected transponder devices, by using the second wireless communication link, to provide the respective audio signal to the respective headphone device.

In one embodiment, the subset can comprise an individual transponder device.

In other embodiments, the subset can also comprise a plurality of transponder devices, in particular all transponder devices.

The selection of the subset to be addressed can be made graphically by the user, for example, at the base station.

In particular, the base station can comprise a graphical display unit and be adapted to allow a user to select the subset by means of the graphical display unit, for example by clicking on symbols assigned to the individual athlete on the graphical display unit.

### BRIEF DESCRIPTION OF THE DRAWINGS

The numerous advantages of the system for training and coordinating athletes according to the disclosure can best be understood on the basis of a detailed description of exemplary embodiments with reference to the attached drawings, in which:

FIG. 1 shows a schematic illustration of a system for training and coordinating athletes according to one embodiment;

FIG. 2 shows a schematic illustration of a headphone device according to one embodiment;

FIG. 3 shows a schematic illustration of a system for training and coordinating a plurality of athletes according to one embodiment; and

FIG. 4 shows the wireless communication in a system for training and coordinating athletes according to one embodiment.

### DETAILED DESCRIPTION OF EMBODIMENTS

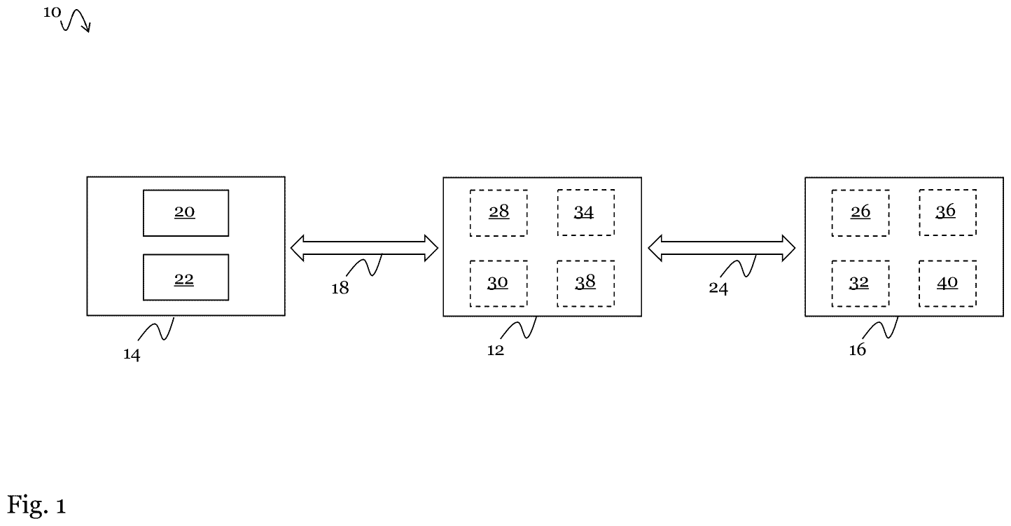

FIG. 1 shows, by way of example, a system 10 which a trainer can use according to one embodiment of the disclosure for addressing and coordinating one or more athletes, for example in a training situation or a competition situation.

The system 10 shown comprises a transponder device 12, a headphone device 14 and a base station 16. Further optional components which can be realized in some embodiments of the system 10 are shown in dashed lines in the illustration of FIG. 1.

The transponder device 12 is adapted to be worn on the body by an athlete, for example to be worn in a vest on the upper body of the athlete.

The headphone device 14 is adapted to be reversibly inserted into an outer auditory canal of an ear of the athlete and to be coupled to the transponder device 12 via a first wireless communication link 18, for example a Bluetooth connection. For example, the headphone device 14 can be an in-the-canal headphone device which is completely received within the external auditory canal of the athlete.

The headphone device 14 comprises a loudspeaker unit 20 for outputting an acoustic signal and a sensor unit 22 for detecting a signal pertaining to the blood circulation of the athlete, for example a heart rate or a blood pressure value of the athlete.

The loudspeaker unit 20 is adapted to receive an audio signal from the transponder device 12 via the first wireless communication link 18, for example the Bluetooth connection, and to output an acoustic signal corresponding to the audio signal into the outer auditory canal of the athlete. The audio signal or acoustic signal can be, for example, voice commands pertaining to the training or sound and sound signals motivating the athlete.

The sensor unit 22 is adapted to record, i.e. to detect, the signal pertaining to the blood circulation of the athlete, for example the heart rate or the blood pressure value, and to transmit it to the transponder device 12 via the first wireless communication link 18.

The base station 16 is adapted to be coupled to the transponder device 12 via a second wireless communication link 24, for example a WiFi connection, and to receive from the transponder device 12 the signal pertaining to the blood circulation of the athlete via the second wireless communication link 24.

The transponder device 12 can therefore serve as a converter which receives the signal pertaining to the blood circulation of the athlete by using a first communication protocol via the first wireless communication link 18, possibly buffers the signal and converts it according to a second communication protocol which differs from the first communication protocol, and transmits the converted signal to the base station 16 by using the second communication protocol via the second wireless communication link 24.

For example, the base station 16 can be used by the athlete or his trainer to monitor, analyze and/or record the signals detected by the sensor unit 22 of the headphone device 14 and pertaining to the blood circulation of the athlete.

In addition, in embodiments of the disclosure, the trainer can transmit voice messages, for example training commands, to the athlete by means of the base station 16. For example, the base station 16 can comprise a microphone unit 26 via which the trainer can input his voice commands. The voice messages can first be transmitted via the second wireless communication link 24 to the transponder device 12 and from there via the first wireless communication link 18 to the loudspeaker unit 20 of the headphone device 14 so that the loudspeaker unit 20 outputs the voice messages directly into the auditory canal of the athlete. In this respect, the transponder device 12 can also serve as a converter for the voice messages.

Alternatively or additionally, with the system 10 shown in FIG. 1, tone and sound signals predefined for the athlete can be played into the auditory canal directly in response to or depending on the recorded signals pertaining to the blood circulation of the athlete by means of the loudspeaker unit 20. The selection of these tone and sound signals can be made directly automatically by the logic of the transponder device 12, and the selected tone and sound signals are transmitted via the first wireless communication link 18 to the loudspeaker unit 20 of the headphone device 14. Or it is the base station 16 which selects the tone and sound signals automatically or controlled by a user input of the trainer in response to the signals pertaining to the blood circulation of the athlete transmitted by the transponder device 12 and transmits them via the second wireless communication link 24 to the transponder device 12, from where they are subsequently forwarded via the first wireless communication link 18 to the loudspeaker unit 20 of the headphone device 14.

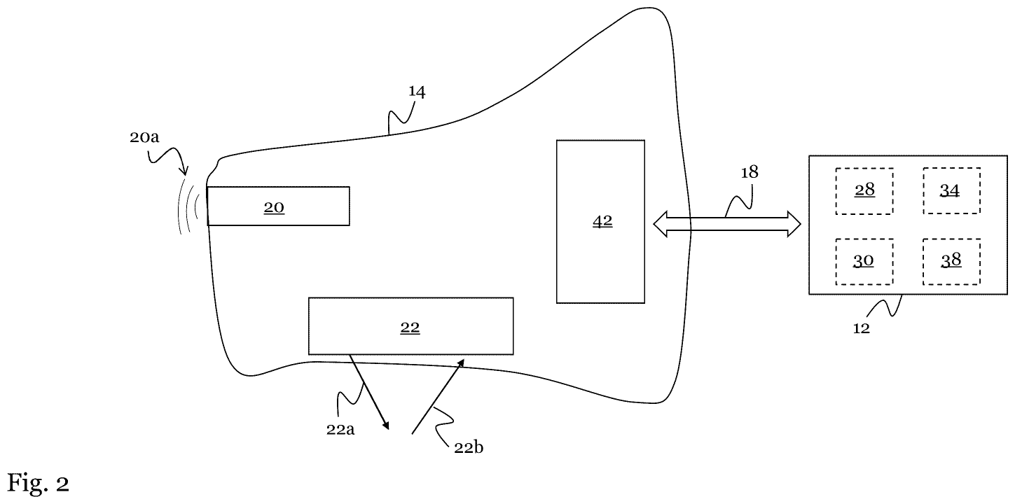

The system 10 according to the disclosure offers a plurality of technical advantages: Since the transponder device 12 and the headphone device 14 are both worn on the body of the athlete, their relative spatial distance is relatively small, typically in the range below 1 m. For the communication connection between the transponder device 12 and the headphone device 14, a short-range and thus low-energy communication protocol, such as Bluetooth, can therefore be used. In the headphone device 14, the energy stores and processor units required for the communication with the transponder device 12 can therefore be formed compactly and integrated in a space-saving manner. The loudspeaker unit 20 and the sensor unit 22 can also be integrated into the headphone device 14 with minimal space requirement. The headphone device 14 can therefore be formed so compactly overall that it can be inserted predominantly or completely into the external auditory canal of an ear of the athlete, for example as an in-the-canal headphone device similar to some modern hearing aids, as will be described below in further details with reference to FIG. 2. In this position, it influences the mobility and performance of the athlete only minimally or not at all. In addition, it does not assume any additional risk of injury in this position if the athlete, for example, falls, collides with an opponent or plays a headball.

The longer-range communication with the base station 16 and the logic for signal processing, which are usually associated with a higher energy consumption and therefore require a larger battery storage and are associated with a higher space requirement, can, in contrast, be outsourced completely to the transponder device 12.

In addition, all further, possibly desirable sensors for capturing additional motion data and/or vital data of the athlete can also be outsourced into the transponder device 12 so that the headphone device 14 can be further functionally relieved and can be configured particularly compactly and with a particularly low energy consumption.

For example, in some embodiments, the transponder device 12 can comprise a motion data sensor unit 28 for capturing motion data of the athlete. The motion data sensor unit 28 can comprise, for example, a gyro sensor for capturing rotational movements of the athlete and/or an acceleration sensor for capturing a magnitude and/or a direction of accelerations of the athlete and/or a magnetic field sensor for determining the orientation of the athlete in space.

The detected motion data can be transmitted to the base station 16 via the second wireless communication link 24 for processing and/or storage. Alternatively or additionally, the detected motion data can also be processed and/or stored locally in the transponder device 12.

In some embodiments, the transponder device 12 can additionally also comprise a position determination unit 30, for example a position determination unit 30 based on satellite navigation such as GPS (Global Positioning System).

The position determination unit 30 can be adapted to detect a GPS signal and to track and store the position of the athlete in space in a time-resolved manner. The detected position signals can additionally transmit the position determination unit 30 to the base station 16 via the second wireless communication link 24. In this way, the trainer can track the position of the corresponding athlete in space in real time, for example on a graphical display unit 32 of the base station 16, or store it in the base station 16 for a later analysis of the training or competition.

For storing the detected signal pertaining to the blood circulation of the athlete and/or the motion data and/or the position data and/or the audio signal and/or the acoustic signal, the transponder device 12 can have a memory unit 34 and the base station 16 can have a memory unit 36. The memory unit 34 and the memory unit 36 can comprise one or more non-volatile and/or volatile memories.

Accordingly, for analyzing the detected signal pertaining to the blood circulation of the athlete and/or the motion data and/or the position data and/or the audio signal and/or the acoustic signal, the transponder device 12 can have an analysis unit 38 and the base station 16 can have an analysis unit 40.

Both the transponder device 12 and the headphone device 14 and the base station 16 can additionally each comprise one or more processor units for processing the detected signals and one or more communication units for receiving and/or transmitting communication signals, for example via the first wireless communication link 18 and/or via the second wireless communication link 24, which are not shown in FIG. 1, in order not to overload the illustration.

FIG. 2 is a schematic illustration of a headphone device 14 as it can be used in embodiments of the disclosure.

The headphone device 14 illustrated in FIG. 2 is an otoplastic, the shape of which is adapted individually to the shape of the auditory canal of the corresponding athlete and which can be inserted completely or almost completely into the external auditory canal of the athlete as a so-called in-the-canal headphone device, comparable to previously known hearing aid solutions. An antenna-like plastic rod or silicone rod (not shown in FIG. 2) can be attached to the outwardly directed side of the headphone device 14, which facilitates removal of the headphone device 14 from the external auditory canal.

An individually manufactured otoplastic ensures an optimal fit in the ear of the athlete. As a result, both a good sealing of the auditory canal from an acoustic point of view can be realized and a good mechanical coupling can be achieved, in order to prevent a possible slipping/falling out of the headphone device 14. The risk of injury to the athlete during the sporting activity can be minimized by the integration into the ear or the external auditory canal which is as complete as possible.

The headphone device 14 illustrated in FIG. 2 comprises the loudspeaker unit 20 for outputting the acoustic signal to the outer auditory canal of the athlete, the sensor unit 22 for detecting a signal pertaining to the blood circulation of the athlete and a communication unit 42 for bidirectional communication with the transponder device 12 via the first wireless communication link 18, for example a Bluetooth connection.

The loudspeaker unit 20 is adapted to receive an audio signal from the transponder device 12 via the first wireless communication link and the communication unit, to convert the audio signal into a speaking acoustic signal and to output it as sound waves 20a in the direction of the eardrum of the athlete. Additional electronics (not shown) in the headphone device 14, in particular in the loudspeaker unit 20, can serve to minimize noise and/or to selectively amplify individual components of the audio signal, for example speech, in order to ensure an optimal communication from the trainer to the player even under difficult environmental conditions, for example in a noisy stadium.

The sensor unit 22 can be formed as an optoelectronic emitter-sensor combination which is adapted to output a modulated optical signal 22a into the outer auditory canal of the athlete. The optical signal 22a is reflected at the blood-permeed vessels of the auditory canal, and a modified reflected optical signal 22b is detected by the sensor unit 22. The reflected optical signal 22b carries information about the blood circulation of the athlete due to its interaction with the blood-permeed vessels of the auditory canal. In particular, by analysis of the reflected optical signal 22b within the scope of photoplethysmography, both the heart rate or pulse frequency of the athlete can be inferred and a blood pressure value of the athlete can be determined, as described, for example, in the patent specifications DE 10 2008 002 747 B4 and EP 3 302 231 B1 and the laid-open specification WO 2007/004083 A1 or the sources referenced therein in further details.

However, the techniques of the present disclosure are not limited to optoelectronic sensors. Within the scope of the disclosure, all sensory techniques can be used which allow an inference about the blood circulation of the athlete, in particular his heart rate and/or his blood pressure.

The headphone device 14 provides the detected sensor data via the communication unit 42 and the first wireless communication link 18 to the transponder device 12, where the sensor data can be analyzed and stored and/or forwarded for further processing via the second wireless communication link 24 to the base station 16, as explained above with reference to FIG. 1 in further details.

The techniques of the disclosure have been described above for simplification and illustration with reference to an individual transponder device 12 and an individual headphone device 14. However, the disclosure is not so limited and particular advantages result in systems which comprise a plurality of transponder devices and a plurality of headphone devices associated with the transponder devices. Such systems are particularly suitable for training in a team sport such as football, basketball or handball,

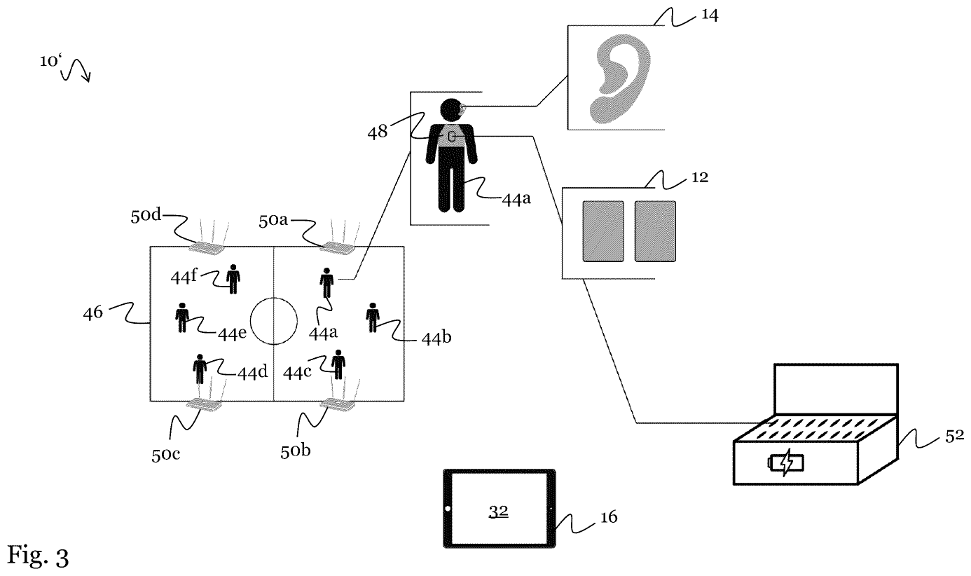

FIG. 3 is a schematic illustration of a system 10′ for training and coordinating a plurality of athletes, for example a plurality of football athletes 44a to 44f.

The system 10′ illustrated in FIG. 3 substantially corresponds to the system 10 described above with reference to FIGS. 1 and 2, and mutually corresponding components bear the same reference signs.

A plurality of football athletes 44a to 44f distributed on a playing field 46 each carry a transponder device 12 and a headphone device 14. The transponder device 12 may correspond to the transponder device 12 described above with reference to FIG. 1 and may be carried by the football athletes 44a to 44f in a vest 48 on the back, for example. The headphone device 14 may be an in-the-canal headphone device as described above in further details with reference to FIG. 2.

By means of one or more Wi-Fi routers 50a to 50d distributed along the circumference of the playing field 46, each of the headphone devices 14 of the football athletes 44a to 44f can exchange messages or data with the base station 16 by using the second wireless communication link 24. The Wi-Fi routers 50a to 50d together cover the entire region of the playing field and communicate with the respective transponder devices 12 of the football athletes 44a to 44f wirelessly via the second wireless communication link 24. They can also be coupled to the base station 16 wirelessly via the second wireless communication link 24 or alternatively or additionally also wired.

In the illustration shown in FIG. 3, the base station 16 is a portable computer or tablet computer which is used by the trainer at the edge of the playing field 46 to give the football athletes 44a to 44f training instructions and/or to track their vital data or position data. The arrangement illustrated in FIG. 3 can correspond, for example, to a training situation or a competition situation.

For example, each of the headphone devices 14 can record a heart rate and/or a blood pressure value of the corresponding football athlete 44a to 44f and transmit it to the base station 16 via the associated transponder device 12 and the Wi-Fi routers 50a to 50d, so that the trainer can track the performance data of the corresponding football athletes 44a to 44f at the base station 16 and can be displayed, for example, on the graphical display unit 32. These performance data can also be stored in the base station 16 in a time-resolved manner for a later analysis.

In embodiments in which the transponder devices 12 transmit their spatial position, for example the shape of a GPS signal, to the base station 16, the base station 16 can display the position of the corresponding football athlete 44a to 44f on the playing field 46 to the trainer in real time on the graphical display unit 32.

Alternatively or additionally, the system 10′ illustrated in FIG. 3 also allows, for example, the position of the football athletes 44a to 44f to be determined by triangulation and/or trilateration on the basis of the communication signals exchanged between the respective transponder device 12 and a plurality of Wi-Fi routers 50a to 50d. For this purpose, the Wi-Fi routers 50a to 50d can in particular be ultra-wideband-capable.

With the aid of the base unit 16, the trainer can additionally select any desired number of football athletes 44a to 44f, i.e. one or more football athletes 44a to 44f or any desired subgroups of football athletes 44a to 44f, or their associated transponder devices 12, and can transmit voice messages to them in a targeted manner via the Wi-Fi routers 50a to 50d which the respective transponder devices 12 then forward in each case to the corresponding associated headphone device 14, as has been described above with reference to FIGS. 1 and 2. These voice messages can be, for example, training commands or game commands during a training or competition.

The selection of the football athletes 44a to 44f by means of the base station 16 for retrieving their respective vital data or for selecting them as a receiver of audio signals can take place, for example, by clicking on corresponding graphical symbols assigned to the respective football athlete 44a to 44f on the graphical display unit 32 or by means of voice control.

In addition, the trainer can play in predefined chimes or tones or sounds via the corresponding headphone device 14 in a targeted manner to individual football athletes 44a to 44f depending on their vital data or the training or competition situations using the base station 16, for example for motivation or for increasing performance. For this purpose, the trainer can select corresponding chimes or tones or sounds on the base station 16 in embodiments, for example by means of the graphical display unit 32 of the base station 16. The base station can then transmit corresponding audio signals via the Wi-Fi routers 50a to 50d to the transponder device 12 of the respectively selected football athlete 44a to 44f, from where the audio signals are then played into the corresponding headphone device 14 by using the Bluetooth connection. Alternatively, the corresponding audio signals can also be pre-stored on the transponder device 12, and the base station 16 transmits only the corresponding selection command to the transponder device 12.

Predefined chimes or tones or sounds can also be automatically played into the corresponding football athlete 44a to 44f via the corresponding headphone device 14, for example depending on the heart rates and/or blood pressure values detected by means of the headphone device 14. In particular, the predefined chimes or tones can also comprise warning signals when specific predefined limit values or ratios of the heart rates and/or blood pressure values detected by means of the headphone device 14 are exceeded. The automated analysis of the heart rates and/or blood pressure values and the generation of the corresponding chimes or tones can take place both locally in the transponder device 12 and in the base station 16. Within the scope of the automated generation of corresponding chimes or tones, techniques of neurolinguistic programming (NLP) can also be used.

The system 10′ illustrated in FIG. 3 also comprises a receiving station 52 for receiving a plurality of or all transponder devices 12. The receiving station 52 can be adapted to electrically charge the transponder devices 12 after the training or game operation.

In addition, the receiving station 52 can be adapted to read out the memory units 34 of the respective transponder devices 12 and to compare or synchronize the obtained data with the data stored in the memory unit 36 of the base station 16. For this purpose, the receiving station 52 can be coupled to the base station 16, e.g., via the second wireless communication link 24, for example by using the Wi-Fi routers 50a to 50d.

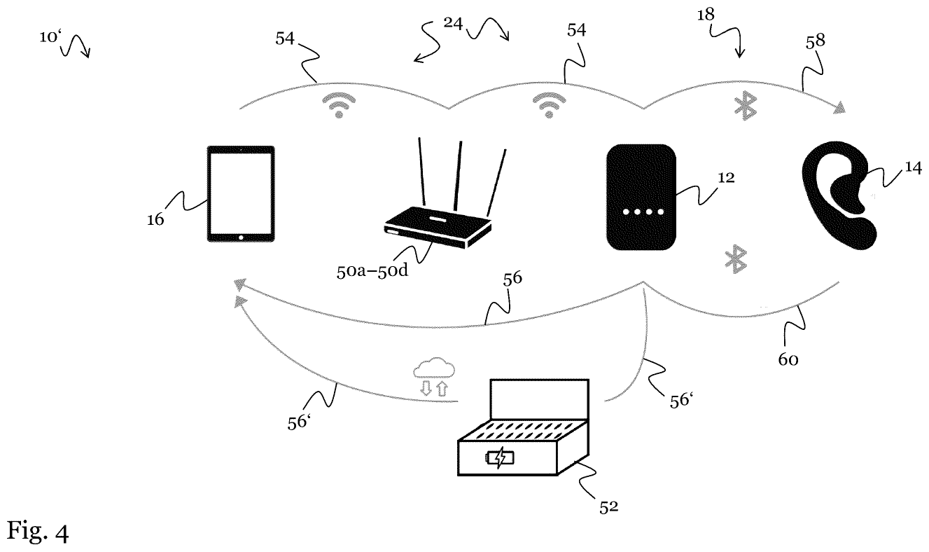

FIG. 4 schematically illustrates the audio and data signals exchanged between the respective components during operation of the system 10′ of FIG. 3.

The second wireless communication link 24 can comprise, for example, a central local Wi-Fi network, which covers the entire playing field 46 and its immediate surroundings. For example, Wi-Fi networks in the frequency range of 2.4 GHz or 5 GHz can serve as a network basis. In some embodiments, the communication via the second wireless communication link 24 can be directed and formed at least partly without a connection. For example, the base station 16 can transmit audio signals to the transponder device 12 by means of the Wi-Fi routers 50a to 50d by using a User Datagram Protocol (UDP) 54. No direct connection between the base station 16 and the transponder device 12 is then necessary for the communication.

In the opposite direction, data, for example the recorded heart rates, blood pressure values or other vital data as well as position data, can be transmitted from the transponder device 12 to the base station 16 via the Wi-Fi routers 50a to 50d, wherein, for example, a Transmission Control Protocol (TCP) link 56 can be used.

The data transmission between the receiving station 52, the base station 16 and the transponder device 12, which was described above with reference to FIG. 3, can also take place via the second wireless communication link 24 by using a TCP 56′.

The first wireless communication link 18 between the transponder device 12 and the associated headphone device 14 can comprise, for example, a Bluetooth connection. Audio signals can be transmitted from the transponder device 12 to the headphone device 14, for example, by using a Bluetooth A2DP protocol 58 (Advanced Audio Distribution Profile) or AptX protocol.

In the opposite direction, the vital data detected by the sensor unit 22 of the headphone device 14, for example a heart rate and/or a blood pressure value of the football player 44a to 44f, can be transmitted to the transponder device 12 in an energy-saving manner by means of a Bluetooth Low Energy (BLE) protocol 60.

In other embodiments, the transmission of the audio signals from the transponder device 12 to the headphone device 14 can also take place by means of a Bluetooth Low Energy (BLE) protocol 60 instead of the Bluetooth A2DP protocol 58 shown in FIG. 4, for example when using the Bluetooth standard 5.2, which provides a BLE audio protocol.

The initial set-up of the Bluetooth connection 18 between the transponder device 12 and the headphone device 14 can take place by means of near-field communication. To establish a pairing, it can then be sufficient to bring the selected transponder device 12 into the spatial proximity of a headphone device 14.

In embodiments, the communication via the second wireless communication link 24 and/or via the first wireless communication link 18 can take place in an encrypted manner in order to secure the exchanged data against unauthorized access.

The disclosure has been explained above using the example of a football training. However, the system 10, 10′ according to the disclosure can also be used in a corresponding manner for any other types of sports and also for animal athletes, for example for tournament horses or racing horses.

The exemplary embodiments described above and the figures serve solely for illustration of the solution according to the disclosure, but should not be understood in a limiting sense. The scope of the disclosure emerges from the attached claims.

### REFERENCE SIGNS

10, 10′ System for training and coordinating athletes
12 Transponder device
14 Headphone device
16 Base station
18 first wireless communication link, Bluetooth connection
20 loudspeaker unit of the headphone device 14
20a sound waves
22 sensor unit of the headphone device 14
22a optical signal emitted by the sensor unit 22
22b reflected optical signal received by the sensor unit 22
24 second wireless communication link, WiFi connection
26 microphone unit of the base station 16
28 motion data sensor unit of the transponder device 12
30 position determination unit of the transponder device 12
32 graphical display unit of the base station 16
34 memory unit of the transponder device 12
36 memory unit of the base station 16
38 analysis unit of the transponder device 12
40 analysis unit of the base station 16
42 communication unit
44a-44f football athletes
46 playing field
48 vest
50a-50d Wi-Fi routers
52 receiving station
54 UDP connection
56,56′ TCP connection
58 A2DP connection
60 BLE connection

1. A system for training and coordinating athletes, comprising:
a transponder device adapted to be worn on the body by an athlete;
a headphone device adapted to be reversibly inserted into an outer auditory canal of an ear of the athlete and to be coupled to the transponder device via a first wireless communication link;
wherein the headphone device includes a loudspeaker unit to outputting an acoustic signal and is adapted to receive an audio signal from the transponder device via the first wireless communication link and output an acoustic signal corresponding to the audio signal into the outer auditory canal of the athlete via the loudspeaker unit;
wherein the headphone device includes a sensor unit to detect a signal pertaining to a blood circulation of the athlete and is adapted to transmit the detected signal to the transponder device via the first wireless communication link; and
a base station coupled to the transponder device via a second wireless communication link and adapted to receive from the transponder device the detected signal via the second wireless communication link.

2. The system of claim 1, wherein the detected signal comprises a heart rate or a blood pressure.

3. The system of claim 1, wherein the sensor unit comprises an optoelectronic sensor.

4. The system of claim 1, wherein the headphone device is an in-the-ear headphone device, in particular an in-the-canal headphone device.

5. The system of claim 1, wherein the transponder device further comprises a motion data sensor unit to detecting motion data of the athlete, wherein the transponder device transmits the motion data to the base station via the second wireless communication link.

6. The system of claim 5, wherein the motion data sensor unit includes a gyro sensor, an acceleration sensor, or a magnetic field sensor.

7. The system of claim 1, wherein the base station is adapted to determine a spatial position of the transponder device.

8. The system of claim 7, wherein the transponder device includes a position determination unit based on satellite navigation, and adapted to transmit its spatial position detected by the position determination unit to the base station via the second wireless communication link.

9. The system of claim 1, adapted to determine the spatial position of the transponder device by means of triangulation and/or lateration, in particular using the second wireless communication link.

10. The system of claim 1, wherein the base station includes a graphical display unit and is adapted to display the determined spatial position of the transponder device on the graphical display unit.

11. The system of claim 1, wherein the base station is adapted to cause the transponder device, by using the second wireless communication link, to provide the audio signal to the headphone device.

12. The system of claim 1, wherein the base station is adapted to transmit the audio signal to the transponder device by using the second wireless communication link.

13. The system of claim 1, wherein the base station includes a microphone unit and is adapted to record sound via the microphone unit and transmit the audio signal, which pertains to the sound, to the transponder device using the second wireless communication link.

14. The system of claim 1, wherein the transponder device or the base station analyze the detected signal provide the audio signal to the headphone device depending on the analysis.

15. A system for training and coordinating athletes, comprising:
a first plurality of transponder devices adapted to be worn by an athlete (44a-44f);
a second plurality of headphone devices reversibly inserted into an outer auditory canal of an ear of the respective athlete and to be-coupled to an associated transponder device of the first plurality of transponder devices via a first wireless communication link;
wherein each of the second plurality of headphone devices comprises a loudspeaker unit to outputting a respective acoustic signal and is adapted to receive a respective audio signal from the associated transponder device via the first wireless communication link and output an acoustic signal corresponding to the respective audio signal into the outer auditory canal of the respective athlete via the loudspeaker unit;
wherein each of the second plurality of headphone devices further comprises a sensor unit to detecting a respective signal pertaining to a blood circulation of the respective athlete and is adapted to transmit the respective detected signal to the associated transponder devices via the first wireless communication link; and
a base station adapted to be coupled to each of the first plurality of transponder devices via a second wireless communication link and to receive from the respective transponder devices the detected signal via the second wireless communication link.

16. The system of claim 15, wherein the detected signal comprises a heart rate or a blood pressure.

17. The system of claim 15, adapted to determine the spatial position of the transponder device by triangulation or lateration using the second wireless communication link.

18. The system of claim 15, wherein the base station includes a graphical display unit and is adapted to display the determined spatial position of the transponder device on the graphical display unit.

19. A method of training and coordinating athletes, comprising:
coupling a transponder device to a person;
reversibly inserting into an outer auditory canal of an ear of the person a headphone device;
coupling the headphone device to the transponder device via a first wireless communication link;
receiving, via the headphone device, an audio signal from the transponder device via the first wireless communication link;
outputting an acoustic signal corresponding to the audio signal into the outer auditory canal of the person via a loudspeaker unit;
detecting, via a sensor unit, a signal pertaining to a blood circulation of the person;
transmitting the detected signal to the transponder device via the first wireless communication link; and
receiving the detected signal, via a second wireless communication link, at a base station coupled to the transponder device.

20. The system of claim 1, wherein the detected signal comprises a heart rate or a blood pressure.
